(19) United States
(12) Patent Application Publication
(10) Pub. No.: US 2019/0012160 A1
(43) Pub. Date: Jan. 10, 2019

(54) DISTRIBUTION METHOD FOR LINUX-BASED OPERATING SYSTEM AND SYSTEM USING THE SAME

(71) Applicant: Wayne Inc., Incheon (KR)

(72) Inventor: Seongbin BAK, Incheon (KR)

(21) Appl. No.: 15/834,927

(22) Filed: Dec. 7, 2017

(30) Foreign Application Priority Data
Jul. 4, 2017 (KR) 10-2017-0084841

(51) Int. Cl. G06F 9/445; G06F 9/44; H04L 29/08; H04L 29/06

(52) U.S. Cl. CPC G06F 8/64; G06F 9/4406; H04L 67/06; H04L 67/42; H04L 67/1002

(57) ABSTRACT

Provided are a distribution method for a Linux-based operating system (OS) and a system using the same. The distribution method comprises (a) acquiring, by a server, information about a client through an information acquirer upon sensing a connection of the client to the server; (b) determining, by the server, the information about the client through an information discriminator; (c) retrieving, by the server, a version and type of an OS corresponding to a storage medium of the client through an information retriever; and (d) transmitting, by the server, the OS retrieved in (c) to the client through an OS installer to allow the client automatically install the OS on the storage medium of the client.

### CROSS-REFERENCE TO RELATED PATENT APPLICATION

This U.S. non-provisional patent application claims priority under 35 U.S.C. § 119 of Korean Patent Application No. 10-2017-0084841 filed on Jul. 4, 2017 in the Korean Patent Office, the entire contents of which are hereby incorporated by reference.

### BACKGROUND

### 1. Technical Field

The present invention relates to a distribution method for an operating system (OS) and a system using the same. More particularly, the present invention relates to a technology capable of distributing an OS including an update through a connection between a server and a client.

### 2. Description of Related Art

An operating system (OS) is an execution manager of a computer system which manages hardware and software, and is sold or offered free of charge by various businesses. Such an OS is referred to by various names, for example, Windows, Unix, or Linux.

The OS is a large collection of individual files that are executed in cooperation with each other to provide an operating environment for a computing device, and is generally installed on a storage medium included in the computing device, for example, a personal computer (PC) to be operated.

In addition, the individual files constituting the OS are typically stored in a complicated arrangement of directories and folders in a computing device, and distribution and deployment of the OS or a part thereof may be a difficult task due to a size and complexity of an OS in a remote computing device, so there is a service in which an OS is installed directly by an operator who distributes the OS, which will be described as follows with reference to Patent Document 1.

Patent Document 1 discloses a system for distributing an OS including a trial or an update by distributing an image file online and allowing the image file to be installed on a portable memory.

However, the system for distributing an OS according to Patent Document 1 is only a technology for identifying whether an OS with a unique number is an unauthorized copy of an OS, and in the case of an unauthorized copy of the OS, setting such that the trial or update is not provided.

### PRIOR-ART DOCUMENT

### (Patent Document)

(Patent Document 0001) Korea Patent Publication No. 2016-0116574

### SUMMARY

### 1. Technical Problem

A technical objective of the present invention is to provide a distribution system for a Linux-based operating system (OS) in which an OS including an update suitable for a client is automatically distributed to the client by only a connection between a server and the client.

### 2. Solution to Problem

A distribution method for a Linux-based operating system (OS) according to an aspect of the present invention comprises: (a) acquiring, by a server, information about a client through an information acquirer upon sensing a connection of the client to the server; (b) determining, by the server , the information about the client through an information discriminator; (c) retrieving, by the server, a version and type of an OS corresponding to a storage medium of the client through an information retriever; and (d) transmitting, by the server, the OS retrieved in the (c) to the client through an OS installer to allow the client to automatically install the OS on the storage medium of the client.

The server may include an information archive configured to store the information acquired by the information acquirer, and an OS database configured to classify files of the OS according to versions and types thereof and to store the files on their classification.

The information acquirer may include a first acquirer configured to acquire a unique value of the storage medium of the client; a second acquirer configured to acquire IP information of the client connected to the server; a third acquirer configured to acquire a distribution date at which files of the OS are distributed and an amount of distribution thereof; and a unique identification unit configured to identify the client by matching the unique value of the storage medium acquired by the first acquirer to a unique value of the storage medium previously stored in the information archive.

The information discriminator may separately store IP information and information about a storage medium of a client which attacks the server to block a connection of the client to the server in advance.

The information retriever may further include an information retriever matching the information about the client acquired by the information acquirer to information about the OS stored in the server.

The OS installer may include an installation guide configured to install the OS on the storage medium of the client and provide a guide for the installation; an encryption module configured to encrypt files of the OS; a file transmitter configured to send the client the files of the OS encrypted by the encryption module.

A distribution server for a Linux-based OS according to another aspect of the present invention comprises a communicator configured to connect to a client; and a processor configured to execute an information acquirer that acquires information about the client through the communicator upon sensing a connection of the client, wherein the processor is further configured to execute: an information discriminator configured to determine the information about the client acquired through the information acquirer; an information retriever configured to retrieve a version and type of an OS corresponding to a storage medium of the client; and an OS installer configured to transmit the OS retrieved by the information retriever to the client to allow the client to automatically install the OS on the storage medium of the client.

The above and other objects, features, and advantages of the present invention should become more apparent to those of ordinary skill in the art by describing exemplary embodiments thereof in detail with reference to the accompanying drawings.

It should be understood that the terms used in the specification and the appended claims are not to be construed as limited to general and dictionary meanings but should be interpreted on the basis of meanings and concepts corresponding to technical aspects of the present invention based on the principle that the inventor is allowed to define terms appropriately for the best explanation.

### 3. Advantageous Effects

According to one embodiment of the present invention, there is an advantageous effect in that information about a storage medium of a client connected to a server is acquired, the acquired information is recorded in an information archive, an operating system (OS) corresponding to the storage medium of the client is retrieved, and the retrieved OS is installed on the storage medium of the client so that the server can select and install the OS by determining the OS by itself without the client needing to separately select a version or type of the OS.

In addition, there is an advantageous effect in that a server automatically retrieves an OS optimal for a storage medium of a client by acquiring a producer-specific value of the storage medium, a product-specific value of the storage medium, and information about a type and capacity of the storage medium that are recorded in the storage medium of the client so that the server can automatically install the OS.

Also, there is an advantageous effect in that a client is identified through a unique value of a storage medium of the client.

### BRIEF DESCRIPTION OF DRAWINGS

FIG. 1 is a block diagram illustrating an operation progress of a distribution system for a Linux-based operating system (OS) according to an exemplary embodiment of the present invention; and

FIG. 2 is a block diagram illustrating a distribution system for a Linux-based OS according to an exemplary embodiment of the present invention.

### DESCRIPTION OF SYMBOLS

10: server
110: information acquirer
111: first acquirer
112: unique identification unit
113: second acquirer
114: IP identification unit
115: third acquirer
120: information archive
121: first archive
122: second archive
123: third archive
130: information discriminator
131: particular manager
140: information retriever
141: information matcher
150: OS database
160: OS installer
161: installation guide
162: file transmitter
163: encryption module
164: partitioner

### DETAILED DESCRIPTION OF EMBODIMENTS

Particular aspects and specific technical features according to the invention disclosed herein may become apparent on the basis of the following descriptions and embodiments relevant to the accompanying drawings. In the following specification, like numbers refer to like elements throughout the description of the figures. In the description of the present invention, detailed descriptions of related known functions or constructions will be omitted to avoid obscuring the subject matter of the present invention.

The terms first, second, A, B, (a), (b), etc. may be used to describe elements of the present invention. These terms are only used to distinguish one element from another element, and thus qualities, the order, or the sequence of the elements is not limited by the terms . It should be understood that when an element is referred to as being “connected” or “coupled” to another element, the element may be directly or indirectly connected or coupled to the other element, or intervening elements may be present.

In this specification, a computing device including a “server” and a “client” is designed to achieve a desired system perform by using a combination of typical computer hardware (e.g., devices that may include computer processors, memories, storages, input devices and output devices, and elements of existing other computing devices; electronic communication devices, such as a router and a switch; electronic information storage systems, such as a network attached storage (NAS) and a storage area network (SAN)) and computer software (instructions that allow a computing device to function in a particular manner). The computing device includes a communicator and a processor, and may directly or indirectly communicate with another computing device through the communicator.

In this specification, a computing device including a server and a client may transmit and receive a request and a response with respect to another computing device that is linked to the computing device through a communicator. As an example, the request and the response maybe achieved by the same TCP session but is not limited thereto. For example, the request and the response may be transmitted and received as UDP datagrams. In addition, the communicator may broadly include a keyboard, a mouse, and other external input devices for receiving commands or instructions.

The processor of the computing device may include a hardware configuration, such as a micro processing unit (MPU) or a central processing unit (CPU), a cache memory, and a data bus. The processor may further include a software configuration of an operating system (OS) and an application performing a specific purpose.

Hereinafter, an exemplary embodiment of the present invention will be described with reference to the accompanying drawings.

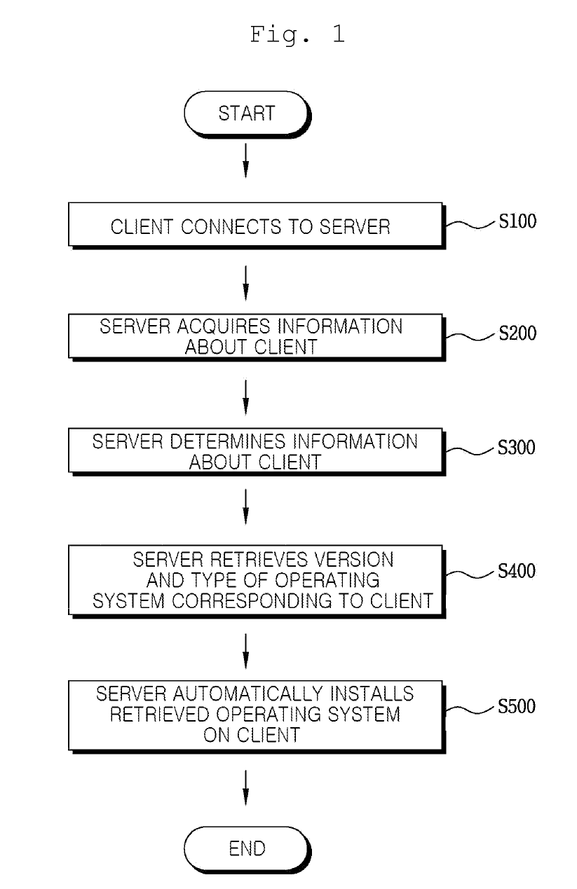

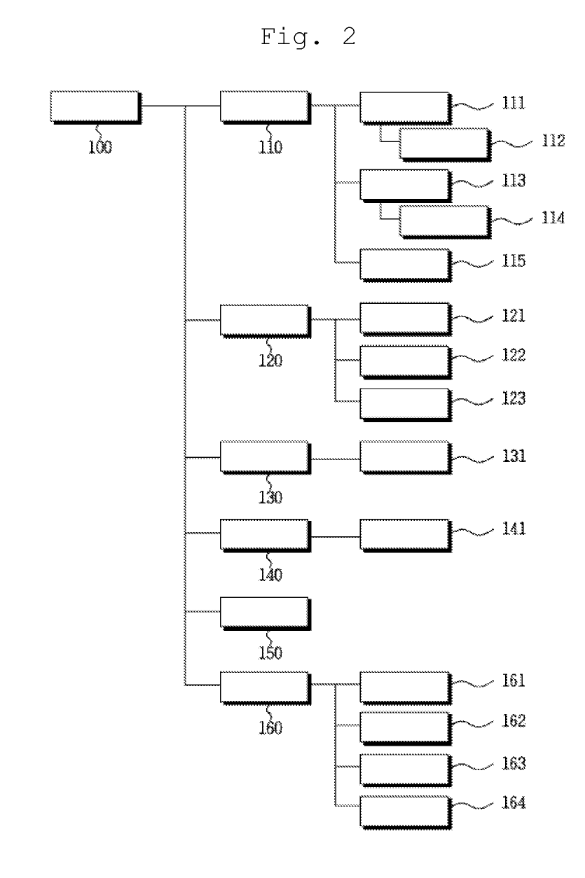

Referring to FIGS. 1 and 2, a distribution system for a Linux-based OS includes (a) connecting, by a client, to a server (S100), (b) acquiring, by the server, information about the client through an information acquirer (S200), (c) determining, by the server, the information about the client through an information discriminator (S300), (d) retrieving, by the server, a version and type of an OS corresponding to a storage medium of the client through an information retriever (S400), and (e) automatically installing the OS retrieved in step (d) on the storage medium of the client through an OS installer (S500).

Operation S100 is an operation in which a client requests that an OS be installed by connecting to a server 100, and when the client requests the installation from the server 100, the server 100 requests information about the client from the client.

The server 100 stores the Linux-based OS based on versions thereof, and when the client requests that the OS be installed from the server 100, the server 100 determines information about a storage medium of the client to provide files of an OS which is optimal for the storage medium.

In addition, the server 100 may operate an Internet homepage to facilitate access of the client, and the server 100 may record an initial access time and an Internet Protocol (IP) of the client before the installation of the OS on the storage medium of the client. The IP may be acquired through a second acquirer 113, which will be described later.

Operation S200 is an operation in which the information about the client is acquired. The server 100 includes an information acquirer 110 configured to acquire the information about the client, for example, information about the storage medium of the client, information about the IP of the client, and information about a type of an interface of the client.

The information acquirer 110 acquires the information about the client, for example, information about a device of the client, a connection IP thereof, and a connection time thereof, and transmits the acquired information to the server 100. The information acquirer 110 includes a first acquirer 111 configured to acquire the information about the storage medium of the client, a second acquirer 113 configured to acquire the IP of the client, and a third acquirer 115 configured to acquire a time during which the client acts in the server 100. It should be understood by one of ordinary skill in the art to which this invention belongs that the information acquired through the information acquirer 110 is not limited to those pieces of information mentioned above, and may include a processor name of the client, a main board manufacturer, a motherboard name, a BIOS/UEFI brand, a BIOS/UEFI version, a memory type, a memory size, a GPU name, a screen resolution, an OS environment of a computing device on which the distribution method for an OS according to the present invention is performed (e.g., Windows 10 Pro 64 bit or the like), and the like.

The first acquirer 111 acquires the information about the storage medium of the client, for example, a unique value of the storage medium, and transmits the acquired information to the server 100. The first acquirer 111 may acquire a producer-specific value of the storage medium, a product-specific value of the storage medium, the type of the storage medium, and the capacity of the storage medium, and may further acquire information about the existence of a defective sector of the storage medium and the existence of a file stored in the storage medium when desired in the server 100.

The first acquirer 111 may include a unique identification unit 112 configured to identify the client by matching the unique value of the storage medium acquired by the serer 100 to a unique value of the storage medium of the client previously stored in the server 100.

The unique identification unit 112 may identify the client connected to the server 100 by acquiring the unique value of the storage medium of the client connected to the server 100 and matching the acquired unique value of the storage medium to a unique value of the storage medium of the client previously stored in the server 100. Even when the client does not additionally sign up for membership, the server 100 may identify the client, and may provide a version of an OS which is an OS most recently provided to the client.

On the storage medium of the client, the producer-specific value of a device, the product-specific value, the product type, and the product capacity are recorded in field values, and an individual storage medium is released with unique value assigned thereto so that the individual storage medium has a unique number recorded therein, and the server 100 is able to identify the storage media by using the unique number recorded in the storage medium.

In addition, the server 100 may identify the storage medium of the client by acquiring the unique number recorded in the storage medium of the client and then matching the unique number to a unique number previously stored in the server 100. This technology will be described in detail with reference to an information discriminator 130, which will be described later.

The second acquirer 113 acquires the IP of the client connected to the server 100 and transmits IP information to the server 100.

The second acquirer 113 may further include an IP identification unit 114 configured to identify the client by matching the IP acquired by the server 100 to an IP previously stored in the server 100.

The IP identification unit 114 may identify the client connected to the server by acquiring the IP of the client connected to the server 100 and then matching the acquired IP to an IP stored in the server 100, may identify the client in the server 100 even when the client does not additionally sign up for a membership, and may automatically provide a version of an OS which is an OS most recently provided to the client.

In addition, the unique identification unit 112 and the IP identification unit 114 may block, for example, a client which causes a Denial of Service (DoS) in the server 100 in advance, thereby providing the client, which is provided with the OS, with a comfortable environment. According to the present embodiment, the client is identified through the unique identification unit 112, but the identifying of the client is not limited thereto . For example, the client may be identified through the IP identification unit 114, or may be identified through the unique identification unit 112 and the IP identification unit 114.

The third acquirer 115 acquires the time during which the client connects to the server 100, the number of times the OS is distributed, and the number of distributions to the client from the server 100, and transmits the acquired information to the server 100.

As such, the information acquirer 110 including the first acquirer 111, the second acquirer 113, and the third acquirer 115 may acquire various types of information in addition to the information about the storage medium of the client, thus providing a comfortable service environment to clients, and the information acquired by the information acquirer 110 may be recorded in data in an information archive 120.

The information archive 120 is a database that stores the information acquired by the information acquirer 110, and is divided into a first archive 121 storing the information about the storage medium of the client acquired by the first acquirer 111, a second archive 122 storing the IP information of the client acquired by the second acquirer 113, and a third archive 123 storing the time during which the client acts in the server 100 acquired by the third acquirer 115 such that the first archive 121, the second archive 122, and the third archive 123 each store a corresponding piece of information.

That is, the information archive 120 is divided into the first archive 121, the second archive 122, and the third archive 123 to record pieces of information so that when information about the storage medium of the client is required, the server 100 searches only the first archive 121 to provide the corresponding information, thereby reducing a retrieval time.

Although the information archive 120 has been illustrated as being divided into the first archive 121, the second archive 122, and the third archive 123 to record pieces of information, the present invention is not limited thereto. For example, information maybe stored in the information archive 120 without being divided and the information archive 120 may be operated in a unified manner.

Meanwhile, the server 100 that acquired information through the information acquirer 110 may determine the information about the client through operation S300.

Operation S300 is an operation in which the information about the client is determined based on the information acquired by the information acquirer 110, and the server 100 may determine the information about the client by selecting at least one of the information of the storage medium and the information of the IP address of the client. For a client which is included in an object to be separately managed by the server 100, the server 100 includes the information discriminator 130 to block an IP of the client.

The information discriminator 130 determines the number of clients request for installation previously recorded in the information archive 120, and when the number of client requests exceeds a predetermined number of requests previously set in the server 100, the information discriminator 130 automatically restrains the client or blocks the connection of the client to the server 100. In this case, the information discriminator 130 may identify the ID of the client through the IP identification unit 114 and block the IP.

In addition, the information discriminator 130 may separately include a particular manager 131 configured to manage IPs of clients by storing information about a client which causes a malicious behavior, such as bringing a server down, so that the client is prevented from connecting to the server 100.

After the information of the client is discriminated through operation S300, an OS optimal for the storage medium of the client is retrieved through step (d).

Operation S400 is an operation in which a version and type of the OS optimal for the storage medium of the client is searched for and the client passing through operation S300 is provided with the OS, and includes an information retriever 140 configured to retrieve the OS optimal for the storage medium of the client.

The information retriever 140 identifies the OS which is optimal for the storage medium of the client by using the information acquired by the information acquirer 110. The information retriever 140 may identify the optimal OS by receiving information about the client which is previously recorded in the information archive 120 or receiving the information of the storage medium of the client which is received from the information acquirer 110.

In detail, when the information about the storage medium of the client coincides with the information previously stored in the information archive 120, the information retriever 140 may identify the optimal OS by using the information received from the information archive 120.

In addition, when a device of the client initially connects to the server 100 such that corresponding information is not recorded in the information archive 120, the information acquirer 110 may acquire the information about the storage medium of the client, an IP thereof, and a date thereof, and the information retriever 140 may identify the optimal OS based on the information acquired by the information acquirer 110.

The information retriever 140 may further include an information matcher 141 configured to match the information acquired from the information acquirer 110 to file information of the OS stored in an OS database 150.

The information matcher 141 may match information previously set in the server 100, and according to the present invention, the information matcher 141 may match the information of the storage medium of the client acquired by the information acquirer 110 to information previously recorded in the information archive 120. In addition to matching the information about the storage medium of the client, the information matcher 141 may match information on an IP through which the client is connected.

The information matcher 141 may serve to match the information about the storage medium of the client or the IP through which the client is connected to the information recorded in the information archive 120 to prevent previously recorded data from being redundantly recorded, and may provide a user who frequently use the server 100 with a comfortable environment by omitting part of a procedure for the client.

The OS database 150 is configured to classify and store files of an OS according to versions and types, separately store information in which the versions and types of the OS are recorded in the server 100, and allow the server 100 to retrieve an OS required by the client.

Although the OS according to the present invention is illustrated as a Linux-based OS stored in the sever 100 and distributed, the present invention is not limited thereto. A Unix-based OS may also be stored and distributed.

After operations S100 to S400 are performed, the OS optimal for the storage medium of the client may be installed through operation S500.

Operation S500 includes an OS installer 160 automatically installing an OS on the storage medium of the client. The OS installer 160 is configured to automatically install files of the OS identified through the information retriever 140 on the storage medium of the client, and includes an installation guide 161 configured to install the OS on the client and guide the installation, a file transmitter 162 configured to transmit the files of the OS to the client, a encryption module 163 configured to encrypt the files of the OS before transmitting the files of the OS, and a partitioner 164 configured to partition the storage medium of the client after the OS is completely installed on the storage medium.

The installation guide 161 guides the client through the installation, and when the server 100 automatically and remotely performs the installation on the storage medium of the client, the installation guide 161 may allow an installation popup to be exposed to the client to inform the client of a present installation progress .

In addition, in the installation of the OS on the storage medium of the client, the installation guide 161 may low-level copy a boot loader, a partition scheme, and files of the OS from the OS database 150 to generate an image file, and copy sectors from sector-0, which is the first sector of the OS, to a sector in which data exists so that data efficiency is maximized. Low-level copying refers to copying in units of bytes, and when the OS is installed in the storage medium of the client by using the distribution method according to the present invention, a region of the storage medium (MBR/GPT header regions including a partition scheme and boot loaders and a VBR region corresponding to a header of each partition) may be subject to the installation through the low-level copying, and the remaining region may be subject to the installation through high-level copying (for example, when only sectors from 0 to 64 and sectors 100 to 110 are subject to low-level copying, a partition scheme is completed, and OS related files are installed on corresponding partitions through high-level copying). As such, when low-level copying and high-level copying are used together, an unallocated region of the storage medium of the client is not subject to the low-level copying so that a time taken to install the OS is reduced.

Although the installation guide 161 has been illustrated as copying sectors from sector-0 to a sector in which data exists, the present invention is not limited thereto. For example, the installation guide 161 may copy sector-0 to a sector which is previously set by the server 100 so that data is effectively managed.

The file transmitter 162 performs division and transmission of the OS on the basis of the total size of the OS so that reliability of the file transmission is ensured.

The encryption module 163 encrypts the files of the OS through a module before the files are transmitted through the file transmitter 162 to ensure security of the files. After the encrypted files are transmitted to the client, the installation guide 161 performs decryption thereon so that the installation of the OS on the storage medium is achieved.

Meanwhile, it should be understood by persons of ordinary skill in the art that when transmitting the files of the OS, the files are compressed for transmission to reduce a time taken to transmit the files through a network, and a client receiving the files is allowed to decompress the files.

When the installation of the OS on the storage medium of the client is completed, the partitioner 164 performs partitioning to utilize the remaining space in the storage medium. In detail, when the total capacity of the storage medium is 16 GB and a file storage space available for installing the OS is 4 GB, partitioning is performed such that the 12 GB of remaining space is used as an additional storage space.

According to the exemplary embodiment of the present invention, information about a storage medium of a client connected to the server 10 is acquired and recorded in the information archive 120, an OS optimal for the storage medium of the client is retrieved, and the retrieved OS is installed on the storage medium of the client so that, without the client needing to additionally select a version and type of the OS, the server 100 itself selects and installs the OS by determining the OS.

While exemplary embodiments of the present invention have been described in detail for illustrative purposes, the distribution system for a Linux-based system according to the present invention is not limited thereto. It should be further understood that the terms “comprises,” “includes,” and/or “has,” when used herein, specify the presence of stated elements but do not preclude the presence or addition of one or more other elements and/or groups thereof unless context dictates otherwise. Unless otherwise defined, all terms (including technical and scientific terms) used herein have the same meaning as commonly understood by one of ordinary skill in the art to which this invention belongs.

On the basis of the above exemplary embodiment, it should be understood by one of ordinary skill in the art that the present invention can be achieved by a combination of software and hardware or by only hardware. Meanwhile, objects of the technical solution of the present invention or portions contributing to the prior art may be implemented in the form of program instructions executable by various computer components and may be recorded in a computer-readable recording medium. The computer-readable recording medium may include program instructions, data files, data structures, and the like alone or in combination with each other. The program instructions recorded in the computer-readable medium maybe program instructions specially designed and constructed for the present invention, or may be program instructions known to those skilled in the art of computer software. Examples of the computer-recordable medium include magnetic media, such as hard disks, floppy disks, and magnetic tape; optical media such as a CD-ROM, a DVD; magneto-optical media, such as floptical disks; and hardware devices specially constructed to store and execute program instructions such as a ROM, a RAM. Examples of the program instructions include both machine code, such as that produced by a compiler, and higher level codes that maybe executed by the computer using an interpreter.

The above-described hardware devices may be configured to act as one or more software modules to perform the operations of the above-described embodiments, or one or more software modules may be configured to act as the above-described hardware devices. In addition, the hardware device may include a processor, such as a CPU or GPU, connected to a memory such as a read only memory (ROM)/a random access memory (RAM) storing program instructions and configured to execute the instructions stored in the memory, and may include a communicator configured to exchange a signal with an external device. In addition, the hardware device may include a keyboard, a mouse, and other external input devices for receiving instructions written by developers.

The above description of the invention is for illustrative purposes, and a person having ordinary skilled in the art should appreciate that other specific modifications may be easily made without departing from the technical spirit or essential features of the invention. Therefore, the exemplary embodiments disclosed in the present invention and the accompanying drawings are intended to illustrate and not limit the technical spirit of the present invention, and the scope of the present invention is not defined by the detailed description set forth above but by the accompanying claims of the invention.

1. A distribution method for a Linux-based operating system (OS) comprising:
(a) acquiring, by a server, information about a client through an information acquirer upon sensing a connection of the client to the server;
(b) determining, by the server, the information about the client through an information discriminator;
(c) retrieving, by the server, a version and type of an OS corresponding to a storage medium of the client through an information retriever; and
(d) transmitting, by the server, the OS retrieved in (c) to the client through an OS installer to allow the client to automatically install the OS on the storage medium of the client.

2. The distribution method for a Linux-based OS according to claim 1,
wherein the server includes an information archive configured to store the information acquired by the information acquirer, and an OS database configured to classify files of the OS according to versions and types thereof and to store the files based on their classification.

3. The distribution method for a Linux-based OS according to claim 1,
wherein the information acquirer includes:
a first acquirer configured to acquire a unique value of the storage medium of the client;
a second acquirer configured to acquire IP information of the client connected to the server;
a third acquirer configured to acquire a distribution date at which files of the OS are distributed and an amount of distribution thereof; and
a unique identification unit configured to identify the client by matching the unique value of the storage medium acquired by the first acquirer to a unique value of the storage medium previously stored in the information archive.

4. The distribution method for a Linux-based OS according to claim 1,
wherein the information discriminator separately stores IP information and information about a storage medium of a client which attacks the server to block a connection of the client to the server in advance.

5. The distribution method for a Linux-based OS according to claim 1,
wherein the information retriever matches the information about the client acquired by the information acquirer to information about the OS stored in the server.

6. The distribution method for a Linux-based OS according to claim 1,
wherein the OS installer includes:
an installation guide configured to install the OS on the storage medium of the client and provide a guide for the installation;
an encryption module configured to encrypt files of the OS;
a file transmitter configured to send the client the files of the OS encrypted by the encryption module.

7. A distribution server for a Linux-based OS, comprising:
a communicator configured to connect to a client; and
a processor configured to execute an information acquirer that acquires information about the client through the communicator upon sensing a connection of the client,
wherein the processor is further configured to execute:
an information discriminator configured to determine the information about the client acquired through the information acquirer;
an information retriever configured to retrieve a version and type of an OS corresponding to a storage medium of the client; and
an OS installer configured to transmit the OS retrieved by the information retriever to the client to allow the client automatically install the OS on the storage medium of the client.
